(19) United States
(12) Patent Application Publication
(10) Pub. No.: US 2014/0026043 A1
(43) Pub. Date: Jan. 23, 2014

(54) COMPUTER PRODUCT, INPUT SUPPORT METHOD, AND INPUT SUPPORT APPARATUS

(71) Applicant: FUJITSU LIMITED, Kawasaki-shi (JP)

(72) Inventor: Kiyoshi TAKEUCHI, Kanazawa (JP)

(73) Assignee: FUJITSU LIMITED, Kawasaki-shi (JP)

(21) Appl. No.: 13/863,501

(22) Filed: Apr. 16, 2013

(30) Foreign Application Priority Data
Jul. 23, 2012 (JP) 2012-162623

(51) Int. Cl. G06F 17/24

(52) U.S. Cl. CPC G06F 17/24
USPC 715/261

(57) ABSTRACT

A computer-readable recording medium stores an input support program that causes a computer to execute a process that includes detecting a nearby character string of one character or more included in an area within a predetermined range of a selected input area on an image displayed on a screen; searching a database correlating and storing item names indicating input items and text examples corresponding to the input items, for a text example that is correlated with an item name indicating an input item corresponding to the detected nearby character string and that corresponds to the character string, upon receiving input of a character string of one character or more to the input area; and outputting as a conversion candidate of the character string, the text example retrieved at the searching.

### CROSS REFERENCE TO RELATED APPLICATIONS

This application is based upon and claims the benefit of priority of the prior Japanese Patent Application No. 2012-162623, filed on Jul. 23, 2012, the entire contents of which are incorporated herein by reference.

### FIELD

The embodiments discussed herein are related to supporting character input.

### BACKGROUND

A conventional technology displays conversion candidates of an input character string. For example, a technology correlates and stores an example sentence and a word used in the example sentence, searches the stored example sentences for example sentences correlated with an input word, displays a list of candidates and, further receives input of an additional word and among the list of candidates, displays example sentence candidates correlated with the additional word. A technology, at a mobile terminal, recognizes an attention word and its surrounding words from an image taken of a document and, at a server, identifies the location of the attention word within the document based on the attention word and its surrounding words output from the mobile terminal, searches for related information corresponding to the attention word, and displays retrieved information on the mobile terminal. For examples, refer to Japanese Laid-Open Patent Publication Nos. 2005-316947 and 2006-146627.

In the case of the conventional technologies, however, it can take time and trouble for a user to select a desired conversion candidate among the conversion candidates displayed in the list in response to the character string input by the user. For example, when there are plural conversion candidates, it can take time and trouble to search the list of the conversion candidates for the desired conversion candidate unless the conversion candidate desired by the user is displayed high in the list of the conversion candidates.

### SUMMARY

According to an aspect of an embodiment, a computer-readable recording medium stores an input support program that causes a computer to execute a process that includes detecting a nearby character string of one character or more included in an area within a predetermined range of a selected input area on an image displayed on a screen; searching a database correlating and storing item names indicating input items and text examples corresponding to the input items, for a text example that is correlated with an item name indicating an input item corresponding to the detected nearby character string and that corresponds to the character string, upon receiving input of a character string of one character or more to the input area; and outputting as a conversion candidate of the character string, the text example retrieved at the searching.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of one example of an input support method according to an embodiment;

FIG. 2 is a block diagram of a hardware configuration of an input support apparatus 100 according to the embodiment;

FIG. 3 is an explanatory diagram of one example of the contents of a text example DB 130;

FIG. 4 is an explanatory diagram of one example of the contents of the determination-use item name file 400;

FIG. 5 is an explanatory diagram of one example of the contents of the item name buffer 500;

FIG. 6 is an explanatory diagram of one example of the contents of the input character string buffer 600;

FIG. 7 is an explanatory diagram of one example of the contents of the determined character string buffer 700;

FIG. 8 is a block diagram of a functional configuration of the input support apparatus 100;

FIG. 9 is an explanatory diagram of one example of the display screen of the conversion candidates at the time of the input of a character into the input area of a “NAME” field;

FIG. 10 is an explanatory diagram of one example of the display screen of the conversion candidates when characters are input to the input area of the “SECTION” field;

FIG. 11 is an explanatory diagram of one example of the acquisition of the area image data;

FIG. 12 is a flowchart of one example of the input support process of the input support apparatus 100;

FIG. 13 is a flowchart (1 of 2) of one example of the item name determination process of the input support apparatus 100;

FIG. 14 is a flowchart (2 of 2) of one example of the item name determination process of the input support apparatus 100;

FIG. 15 is a flowchart of one example of the text example display process of the input support apparatus 100; and

FIG. 16 is a flowchart of one example of the text example registration process at the input support apparatus 100.

### DESCRIPTION OF EMBODIMENTS

Preferred embodiments of the present invention will be explained with reference to the accompanying drawings.

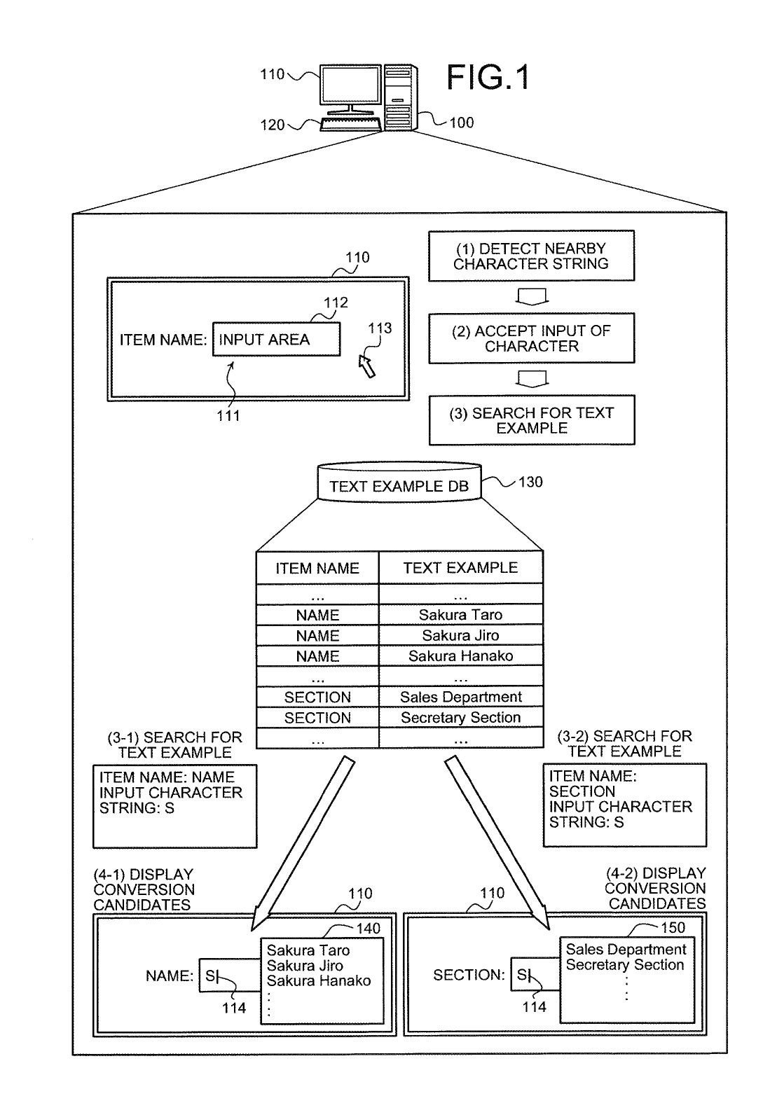

FIG. 1 is an explanatory diagram of one example of an input support method according to an embodiment. In FIG. 1, an input support apparatus 100 is a computer to support a character input operation by a user. For example, the input support apparatus 100 is a personal computer (PC), a notebook PC, a mobile phone, a smartphone, etc. in which word processing software, a text editor, an input method editor (IME), etc. are installed.

The input support apparatus 100 has a display screen 110 and an input device 120. The display screen 110 displays a variety of information. The input device 120 includes for example, a keyboard, a mouse, etc. For example, the display screen 110 displays, by a graphical user interface (GUI), the character input from the keyboard and displays a cursor moving in response to operation of a mouse.

An example will be described of an input screen to be displayed on the display screen 110. An input screen 111 is a screen for receiving input of characters and for example, includes an input area 112 at which the characters are input for each input item. For example, a character string of one character or more corresponding to the input item is input at the input area 112.

In the example of FIG. 1, an item name indicating the input item of the input area 112 is displayed on the left side of the input area 112. For example, a name, a section, an address, a managerial position, a work location, etc. are among the item names. For example, when the input item of the input area 112 is “NAME”, the user inputs his or her name at the input area 112, using the input device 120.

In the GUI, a cursor 113 is, for example, arrow-shaped and changes its display form depending on the place at which the cursor 113 is located, namely, depending on the image on which the cursor 113 is superimposed. For example, in the GUI, at the time of indicating a character input position by the word processing software, the text editor, etc., the cursor 113 changes its display form, for example, to a bar shape called a caret 114 and indicates the input position between characters. The caret 114, for example, is displayed blinking in the mode of receiving character input.

In the following description, the cursor at the time of receiving character input is sometimes described as “caret” (e.g., caret 114) and the cursor excluding the caret is sometimes described as a “mouse pointer”. The character string of one character or more input in the input area (e.g., input area 112) is sometimes described as an “input character string”.

At the input area 112, a character is input at the position of the caret 114 according to the setting of an input specification. For example, at the input area 112, phonetic spelling is input in the case of setting of phonetic spelling input and alphabet is input in the case of setting of direct input. Phonetic spelling input is used, for example, for inputting Japanese and is a technique of inputting the input phonetic spelling after converting it to other characters such as kanji. The direct input is a technique of merely inputting the input characters without conversion to other characters.

An operation example will be described in a case of displaying conversion candidates of an input character string input to the input area 112, using an example of the operation of an existing IME. In the existing IME, for example, when the input area 112 is clicked, the IME is started and when a character is input at the position of the caret 114, a text example having the input character string at the head is displayed as the conversion candidate. In this case, if there are plural text examples, the text example selected most frequently or selected most recently, based on, for example, selection frequency, selection history, etc. of each text example, is displayed higher in the list of the conversion candidates.

For example, when the user attempts to input his name into the input area 112, text examples other than his name (e.g., text examples of departments/sections) have a low possibility of being selected by the user even if the frequency of selection is high. If the text example desired by the user is not displayed high in the list of the conversion candidates, it takes time and trouble to search the list of the conversion candidates for the text example desired by the user. Namely, when the list of the conversion candidates is displayed based on the selection frequency, the selection history, etc. of the text examples, the conversion candidate (text example) desired by the user cannot be listed high in the list of the conversion candidates and the input operation of the user in selecting the conversion candidate can be troublesome.

Accordingly, in this embodiment, the input support apparatus 100 searches for text examples corresponding to the item name of the input area 112 to be identified from the character string around the input area 112, as conversion candidates of the input character string input to the input area 112. Thus, the conversion candidates to be presented to the user can be narrowed down according to the input position on the input screen 111, making it easy for the user to select the conversion candidate desired from the list of the conversion candidates. An embodiment of an input support process of the input support apparatus 100 will be described using an example where an input operation of inputting characters at the input area 112 on the input screen 111 is supported.

(1) The input support apparatus 100 detects a nearby character string of the input area 112 on the input screen 111. The nearby character string is a character string of one character or more included in an area within a predetermined range of the input area 112, namely, a character string located around the input area 112. For example, when consequent to a user input operation via the input device 120, the input area 112 is selected via a mouse pointer positioned at the input area 112, the caret 114 blinks, indicating a state of accepting the input of the characters. In this case, the input support apparatus 100 searches for a nearby character string of the selected input area 112.

A nearby character string is detected by analyzing image data of the area within the predetermined range of the input area 112. The predetermined range is a range specifying a limited area around the input area 112. The area within the predetermined range may be, for example, a specific area on the left side of or above the input area 112, parallel to the input area or may be the entire area of the input screen 111.

Range information to identify the area within the predetermined range of the input area 112 is preset. This range information may be preset, for example, according to the application software in use (hereinafter referred to as “application”).

(2) The input support apparatus 100 receives the input of a character to the selected input area 112. For example, the input support apparatus 100 receives the input of a character string of one character or more to the input area 112 by a user input operation via the input device 120.

(3) When the character is input to the input area 112, the input support apparatus 100 searches a text example database (DB) 130, for a text example that is correlated and stored with the item name corresponding to the detected nearby character string and that corresponds to the input character string input to the input area 112. A text example corresponding to the input character string is, for example, a text example that includes the input character string at the head. The text example DB 130 is a database correlating and storing item names indicating the input item and text examples to be input to the input area 112 of the input item.

The item name corresponding to the nearby character string, for example, may be one whose character string matches the nearby character string or may be one that includes part or all of the nearby character string. A text example is one example of a character string to be input to the input area 112 and is a word of one character or more, or is a string of words. A text example is displayed as a conversion candidate and, when selected by a user input operation, is input to the input area 112.

For example, the text example DB 130 stores, correlated with the item name “NAME”, the text example “Sakura Taro” as one example of “NAME”. For example, the text example DB 130 stores, correlated with the item name “SECTION”, the text example “Sales Department” as one example of “SECTION”.

A case is assumed in which “NAME” is detected as a nearby character string and the character “S” is input to the input area 112 by direct input.

(3-1) In this case, the input support apparatus 100 searches the text example DB 130, for a text example that is stored correlated with the item name “NAME” corresponding to the nearby character string and that includes the input character string “S” at the head. In the example of FIG. 1, for example, text examples including the input character string “S” at the head, “Sakura Taro”, “Sakura Jiro”, and “Sakura Hanako”, are retrieved.

(4-1) The input support apparatus 100 outputs the retrieved text examples as conversion candidates of the input character string “S”. In the example of FIG. 1, a conversion candidate list 140 including “Sakura Taro”, “Sakura Jiro”, and “Sakura Hanako” is displayed on the display screen 110 as conversion candidates of the input character string “S”.

Next, a case is assumed in which “SECTION” is detected as a nearby character string and the character “S” is input to the input area 112 direct input.

(3-2) In this case, the input support apparatus 100 searches the text example DB 130, for a text example that is stored correlated with the item name “SECTION” corresponding to the nearby character string and that includes the input character string “S” at the head. In the example of FIG. 1, for example, text examples including the input character string “S” at the head, “Sales Department” and “Secretary Section”, are retrieved.

(4-2) The input support apparatus 100 outputs the retrieved text examples as conversion candidates of the input character string “S”. In the example of FIG. 1, a conversion candidate list 150 including “Sales Department” and “Secretary Section” is displayed on the display screen 110 as conversion candidates of the input character string “S”.

When plural nearby character strings of the input area 112 are detected, the input support apparatus 100 may search the text example DB 130, for a text example that is stored correlated with the item name corresponding to a nearby character string and that includes the input character string at the head, the input support apparatus 100 searching for text examples for each of the detected nearby character strings. Alternatively, the input support apparatus 100 may search for a text example that is stored correlated with the item name corresponding to the nearby character string displayed nearest the input area 112 among the detected nearby character strings, and that includes the input character string at the head.

Thus, the input support apparatus 100 according to this embodiment enables detection of a nearby character string of the input area 112 and identification of the item name of the input area 112 based on the detected nearby character string. The input support apparatus 100 enables retrieval (from the text example DB 113) of text examples that are stored correlated with the item name of the input area 112 and that include the input character string input to the input area 112 at the head.

Thus, the conversion candidates to be presented to the user can be narrowed down, according to the input position on the input screen 111. For example, text examples that match the circumstances of input, such as a name being input or a section name being input to the input area 112, can be presented to the user as conversion candidates of the input character string.

As a result, as compared with a case in which a list of the conversion candidates arranged based on the selection frequency, the selection history, etc. is displayed, the selection of a conversion candidate desired by the user becomes easier, namely, the selection of a text example to be input to the input area 112, from the list of the conversion candidates becomes easier, enhancing convenience for the user when inputting characters.

According to the input support apparatus 100, text examples can be searched for based on a nearby character string of the input area 112 and the input character string, irrespective of the application in use. Therefore, in implementing the input support process of the input support apparatus 100 described above, it is not necessary to make code changes or setting changes of the application nor is it necessary to perform maintenance of the application in response to the changes such as an addition of a new item name.

While, in the example of FIG. 1, a case has been described in which the text example DB 130 correlates and stores only item names and text examples, the text example DB 130 is not limited hereto. For example, the text example DB 130 may correlate and store phonetic spellings, item names, text examples in kanji, to display conversion candidates consequent to phonetic spelling input. For example, the text example DB 130 may correlate and store the phonetic spelling “ [symbol] ”, the item name “NAME”, and the text example “ [symbol] ”. In this case, for example, when the nearby character string is “NAME”, upon input of the character “ [symbol] ” via the phonetic spelling input, the input support apparatus 100 retrieves the text example “ [symbol] ” that is stored correlated with the item name “NAME” and that includes reading of the input character string “ [symbol] ” at the head.

The input support apparatus 100 may be a server capable of communicating with a PC, a mobile phone, a smartphone, etc. For example, character input to the PC or the smartphone may be such that each time a character is input, communication is made to the server, whereby the server searches for conversion candidates, and the conversion candidates received from the server are displayed on the display of the PC or the smartphone.

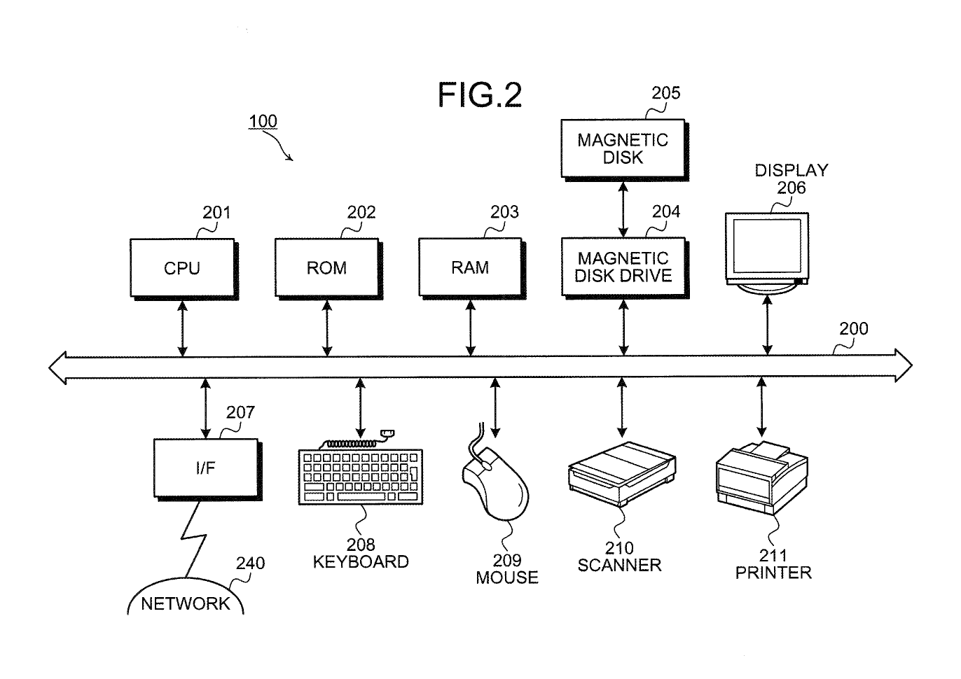

For example, the PC or the smartphone transmits the information of the nearby character string of the input area 112 and the information of the input character string to the server. The server identifies the item name of the input area 112 from the information of the nearby character string received from the PC or the smartphone, searches for a text example that is correlated with this item name and that includes the input character string at the head, and transmits search results to the PC or the smartphone. The PC or the smartphone displays the search results received from the server on a display 206 (see FIG. 2). Thus, conversion candidates desired by the user can be presented.

FIG. 2 is a block diagram of a hardware configuration of an input support apparatus 100 according to the embodiment. As depicted in FIG. 2, the input support apparatus 100 includes a central processing unit (CPU) 201, a read-only memory (ROM) 202, a random access memory (RAM) 203, a magnetic disk drive 204, a magnetic disk 205, a display 206, an interface (I/F) 207, a keyboard 208, a mouse 209, a scanner 210, and a printer 211, respectively connected by a bus 200.

The CPU 201 governs overall control of the input support apparatus 100. The ROM 202 stores therein programs such as a boot program. The RAM 203 is used as a work area of the CPU 201. The magnetic disk drive 204, under the control of the CPU 201, controls the reading and writing of data with respect to the magnetic disk 205. The magnetic disk 205 stores therein data written under control of the magnetic disk drive 204.

The input support apparatus 100 may have an optical disk drive and an optical disk. The optical disk drive, under the control of the CPU 201, controls the reading and writing of data with respect to the optical disk. The optical disk stores therein data written under control of the optical disk drive, the data being read by a computer.

The display 206 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 206. The display 206 corresponds to the display screen 110 depicted in FIG. 1.

The I/F 207 is connected to a network 240 through a communication line and is connected to other apparatuses through the network 240. The I/F 207 administers an internal interface with the network 240 and controls the input/output of data from/to external apparatuses. For example, a modem or a LAN adaptor may be employed as the I/F 207.

The keyboard 208 includes, for example, keys for inputting letters, numerals, and various instructions and performs the input of data. Alternatively, a touch-panel-type input pad or numeric keypad, etc. may be adopted. The mouse 209 is used to move the cursor, select a region, or move and change the size of windows. A track ball or a joy stick may be adopted provided each respectively has a function similar to a pointing device. The keyboard 208 and the mouse 209 correspond to the input device 120 depicted in FIG. 1.

The scanner 210 optically reads an image and takes in the image data into the input support apparatus 100. The scanner 210 may have an optical character reader (OCR) function as well. The printer 211 prints image data and text data. The printer 211 may be, for example, a laser printer or an ink jet printer. The input support apparatus 100 may be configured omitting, for example, the scanner 210 and the printer 211 among the components above.

An example will be described of the contents of the text example DB 130 retained by the input support apparatus 100. The text example DB 130 is implemented, for example, by the storage device such as the RAM 203 and the magnetic disk 205 depicted in FIG. 2.

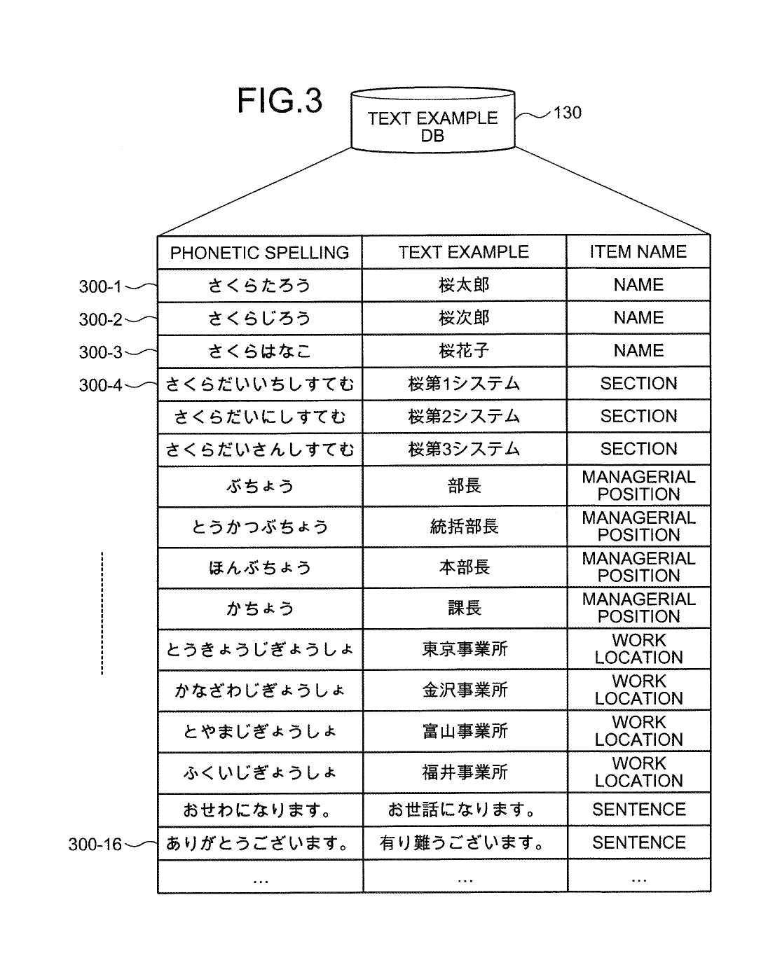

FIG. 3 is an explanatory diagram of one example of the contents of the text example DB 130. In FIG. 3, the text example DB 130 has a phonetic spelling field, a text example field, and an item name field. Consequent to the entering of information into these fields, the text example DB 130 stores text example data 300-1 to 300-16, combinations of the phonetic spelling, the text example, and the item name, as records.

The phonetic spelling indicates a character string consequent to phonetic spelling input performed by the user. A text example indicates an established character string converted from a character string input via phonetic spelling input, into another character string such as kanji. The item name indicates the item type of the input character string to be input to the input area, such as the name, the section, the address, the managerial position, the work place, and the text example.

For example, the text example data 300-1 is the data correlating the phonetic spelling “ [symbol] ”, the text example “ [symbol] ”, and the item name “NAME” to one another. For example, the text example data 300-4 is the data correlating the phonetic spelling “ [symbol] [symbol] ”, the text example “ [symbol] ”, and the item name “SECTION”. The text example DB 130 stores the text example data 300-1 to 300-16.

In the text example data 300-1 to 300-16, history information such as the number of times, the frequency, and the time at which the text example was selected by the user is also stored correlated with the text example, though not depicted. The history information is, for example, information such as the date and time at which a given text example was first registered and the number of times, the frequency, and the date and time at which the given text example was selected by the user after the registration. The number of times is the past cumulative number of times the given text example was selected by the user. The frequency is the cumulative number of times the given text example was selected by the user, for example, within the most recent one month. The date and time is the date and time at which the given text example was selected by the user.

When there is a text example not registered in the text example DB 130, the input support apparatus 100 causes the text example DB 130 to store text example data 300 correlating the text example, the input phonetic spelling, and the detected item name to one another. When there is a text example registered in the text example data DB 130, the input support apparatus 100 updates the history information correlated with the text example data.

While in this embodiment, in which the target language is specified as Japanese, the phonetic spelling field is set in the text example DB 130, configuration may be such that the phonetic spelling field is not be set in the text example data 300, depending on the target language. For example, if the target language by which direct input is performed and does not use phonetic spellings such as English, the text example data 300 may be data correlating the item name and the text example, without provision of the phonetic spelling field.

In the case of Pinyin expressions in which Chinese is expressed in Roman letters, configuration may be such that a Chinese phonetic spelling field will be provided that corresponds to the phonetic spelling field and the text example data 300 will be data storing, for example, “Beijing” in the Chinese phonetic spelling field as well as storing “ [symbol] ” as the text example.

The phonetic spelling field is not necessarily required to store all characters of the phonetic spelling and may be designed to store, for example, a predetermined number of characters (e.g., 10 characters) from the head. For example, the phonetic spelling “ [symbol] [symbol] ” of the text example data 300-4 is composed of 11 characters and this may be shortened to 10 characters by deleting the last character “ [symbol] ”. This can reduce data volume.

An example will be described of the contents of a determination-use item name file 400 retained by the input support apparatus 100. The determination-use item name file 400 is stored, for example, in a storage device such as the ROM 202, the RAM 203, and the magnetic disk 205 depicted in FIG. 2.

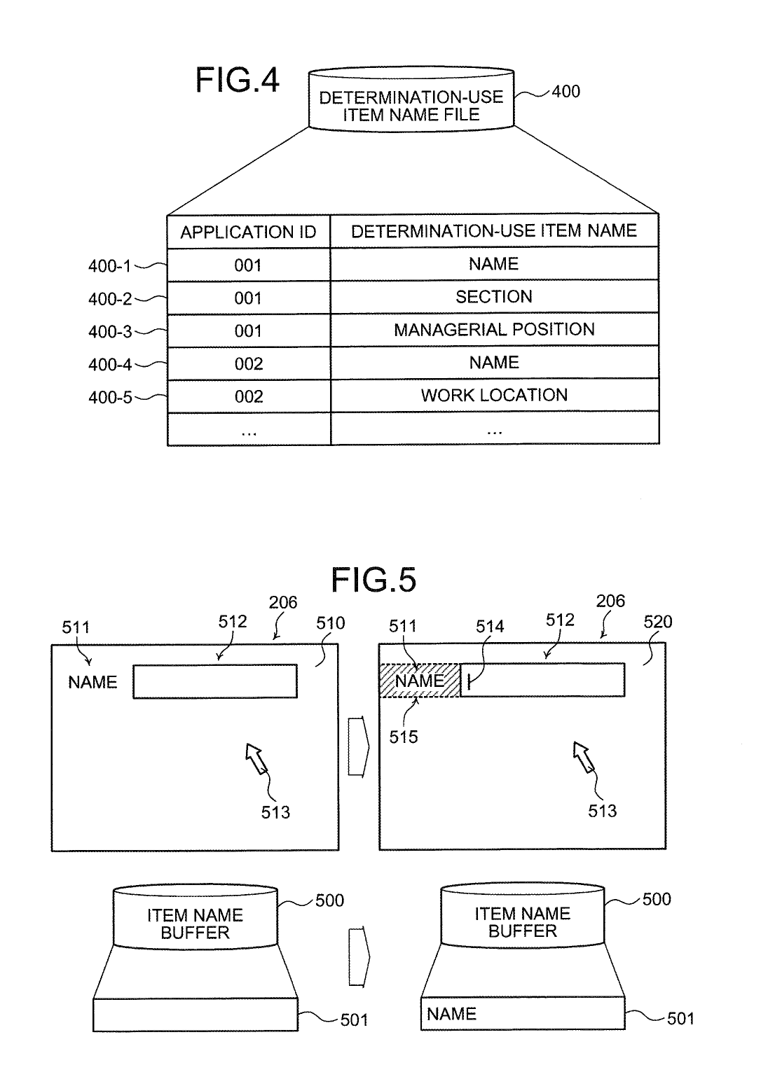

FIG. 4 is an explanatory diagram of one example of the contents of the determination-use item name file 400. In FIG. 4, the determination-use item name file 400 has an application ID field and a determination-use item name field. Consequent to the entering of information into these fields, the determination-use item name file 400 stores determination-use item name data 400-1 to 400-5, combinations of the application ID and the determination-use item name as records.

The determination-use item name file 400 is, for example, a file preliminarily made at the stage of production, etc. The determination-use item name file 400 is used for narrowing down the item names among the detected nearby character strings. For example, while it is anticipated that various character strings displayed are detected as the nearby character string, the determination-use item name file 400 is used to detect a candidate for the item name among the detected character strings.

In the determination-use item name file 400, the application ID is the information to identify the application being executed. An application being executed as used in this embodiment is, for example, the application that is in the so-called active window displayed in the foreground out of plural window screens.

The determination-use item name represents the input item such as, for example, the name, the section, the address, the managerial position, the work location, and the text example, and is used for determination of the narrowing-down of the detected nearby character strings. For example, “NAME”, “SECTION”, and “MANAGERIAL POSITION” as the determination-use item name are mapped to the application ID “001”. Namely, this indicates that only “NAME”, “SECTION”, and “MANAGERIAL POSITION” are included as the item name of the input area to be displayed in the application of the application ID “001”.

An example will be described of the contents of an item name buffer 500 retained by the input support apparatus 100. The item name buffer 500 is implemented, for example, by the storage device such as the RAM 203 and the magnetic disk 205 depicted in FIG. 2.

FIG. 5 is an explanatory diagram of one example of the contents of the item name buffer 500. In FIG. 5, a display screen 510 on the display 206 displays a nearby character string 511, an input area 512, and a mouse pointer 513. The display screen 510 is not in the state to accept the character inputting to the input area 512. When character input to the input area 512 is not performed, the item name data 501 is not stored to the item name buffer 500.

When the user operates and clicks the mouse 209 while the mouse pointer 513 is positioned at the input area 512, a Japanese IME as software to support Japanese input is turned on and a caret 514 blinks. The display screen 510 transitions to a display screen 520 that accepts character input. The input support apparatus 100 detects the nearby character string 511 of the input area 512. The nearby character string 511 is detected by performing an image analysis of a predetermined area 515 on the left side of the input area 512. The detected nearby character string 511 is stored to the item name buffer 500 as item name data 501.

The input support apparatus 100 refers to the determination-use item name file 400 depicted in FIG. 4 and when the detected nearby character string 511 matches the determination-use item name corresponding to the application ID of the application being executed, the input support apparatus 100 causes the detected nearby character string 511 to be stored to the item name buffer 500 as the item name data 501. Assuming that, for example, during the execution of the application of the application ID “001”, three character strings of “NAME”, “MONTH/DAY”, “PHONE NUMBER” are detected as the nearby character string 511. In this case, since only “NAME” meets the determination-use item name of the application ID “001”, only “NAME” can be stored to the item name buffer 500, while other nearby character strings are excluded.

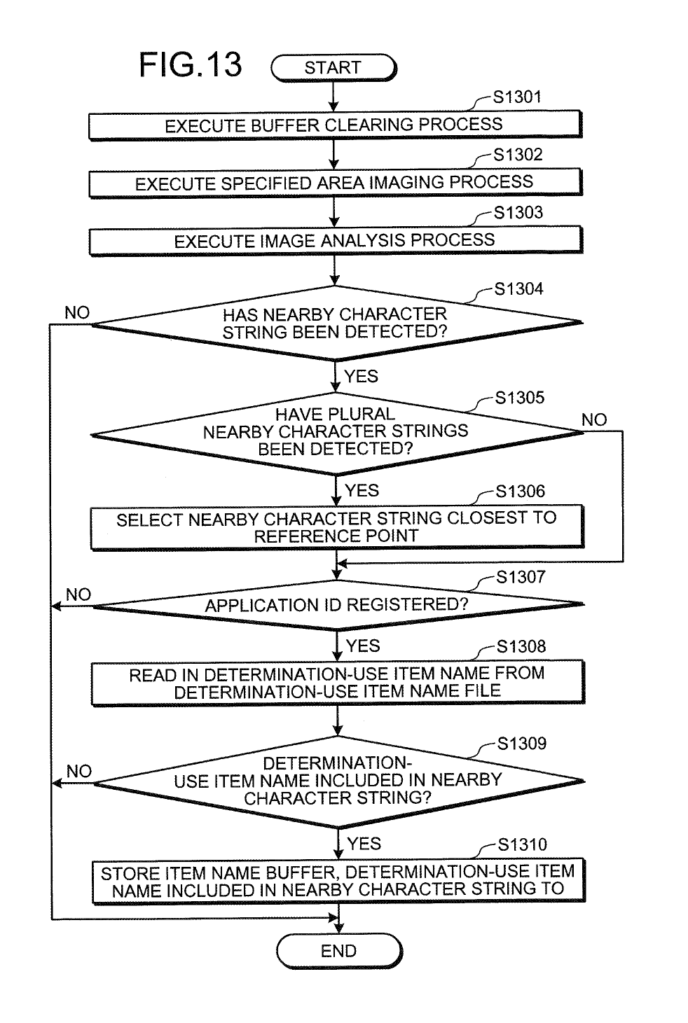

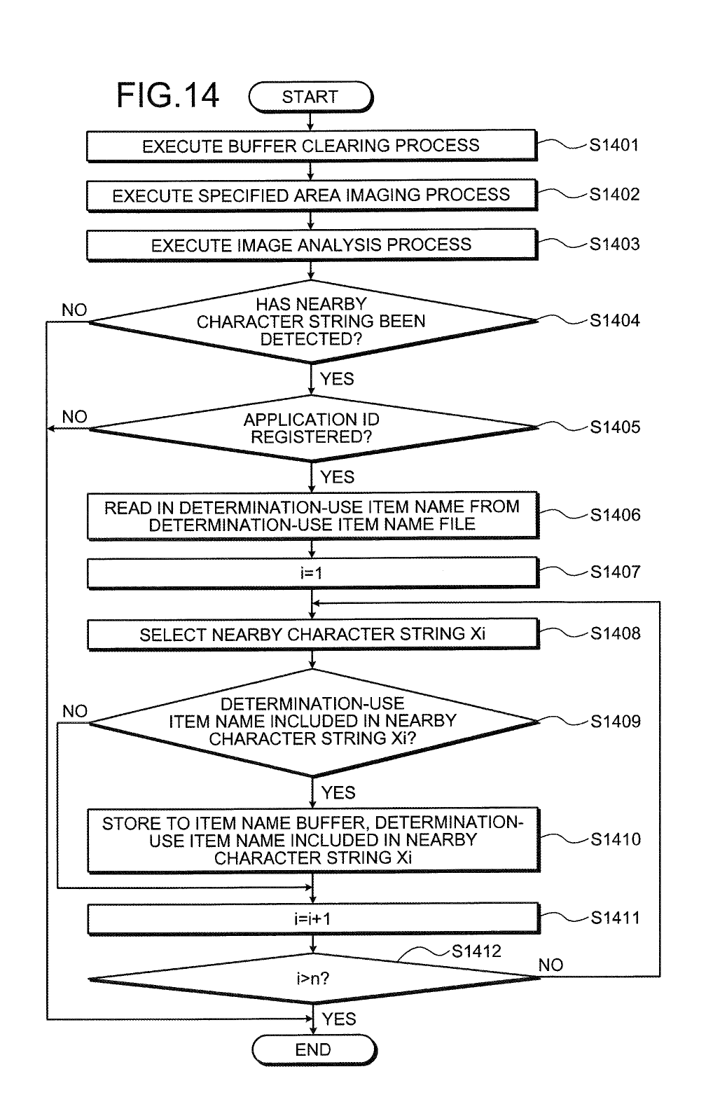

Storage of the item name data 501 to the item name buffer 500 is performed in an item name determination process to be described later with reference to FIG. 13 or 14. In this embodiment, although the storage of the item name data 501 to the item name buffer 500 is performed when the caret 514 on the display screen 520 blinks, not limited hereto, storage may be performed when the caret 514 is not blinking. For example, configuration may be such that, as depicted in the display screen 510, when the image of the input area 512 is displayed, the image analysis of the input area 512 and the predetermined area 515 will be performed to detect the nearby character string 511 and the detected nearby character string 511 will be stored to the item name buffer 500 as the item name data 501.

Configuration may be such that, in the background in which the image of the input area 512 is not yet displayed, image analysis of the input area 512 and of the predetermined area 515 will be performed to detect the nearby character string 511 and the detected nearby character string 511 will be stored to the item name buffer 500 as the item name data 501. Since this enables preliminary storage of the item name data 501 prior to character input, the load of processing in the case of character input simultaneous with the blinking of the caret 514 can be alleviated.

The storage of the item name data 501 to the item name buffer 500 may be performed when the character is input. For example, configuration may be such that, when the character is input, image analysis of the input area 512 and of the predetermined area 515 will be performed to detect the nearby character string 511 and the detected nearby character string 511 will be stored to the item name buffer as the item name data 501.

An example will be described of the contents of an input character string buffer 600 retained by the input support apparatus 100. The input character string buffer 600 is implemented, for example, by a storage device such as the RAM 203 and the magnetic disk 205 depicted in FIG. 2.

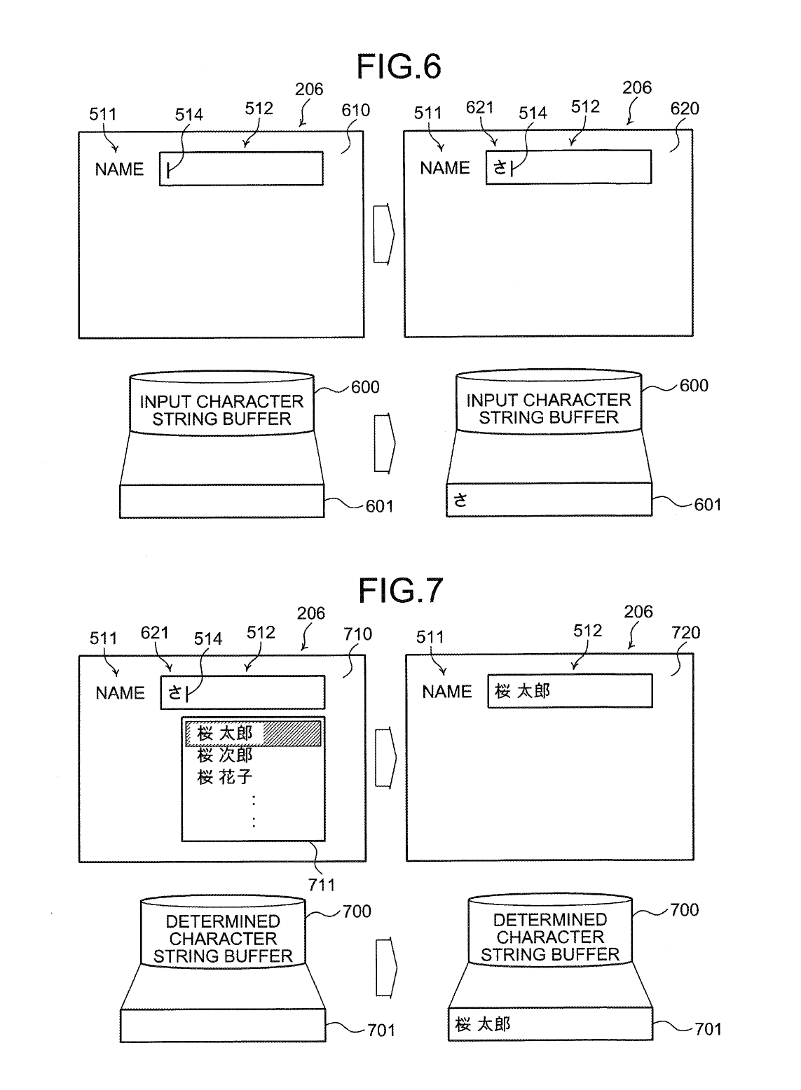

FIG. 6 is an explanatory diagram of one example of the contents of the input character string buffer 600. In FIG. 6, a display screen 610 on the display 206 displays the nearby character string 511, the input area 512, and the caret 514. The caret 514 in the input area 512 is blinking, which indicates a stand-by state to accept character input to the input area 512. When character input to the input area 512 is not performed, input character string data 601 is not stored to the input character string buffer 600.

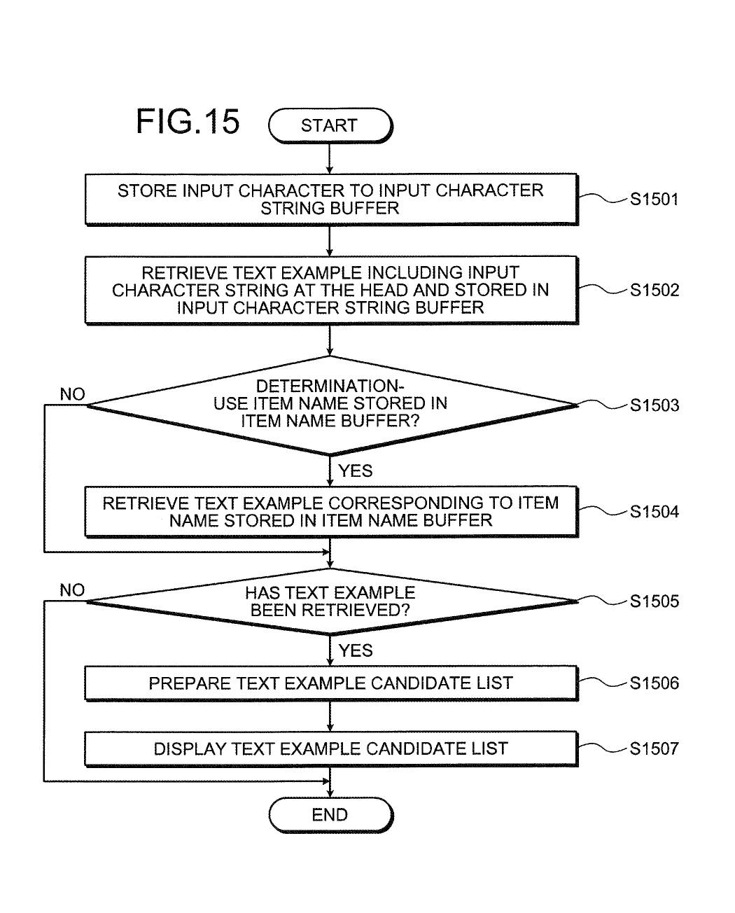

When the user operates the keyboard 208 and an input character string 621 is input to the input area 512, the display screen 610 transitions to a display screen 620. The input character string 621 is stored to the input character string buffer 600 as the input character string data 601. For example, if “ [symbol] ” is input, then “ [symbol] ” is input to the input character string buffer 600, without waiting for a determination of whether the input “ [symbol] ” is hiragana “ [symbol] ” or another character string such as “ [symbol] ” or “ [symbol] ”. When “ [symbol] ” or “ [symbol] ” is determined and then is input, “ [symbol] ” or “ [symbol] ” is input to the input character string buffer 600. Storage of the input character string data 601 to the input character string buffer 600 is performed in a text example display process to be described later with reference to FIG. 15.

An example will be described of the contents of a determined character string buffer 700 retained by the input support apparatus 100. The determined character string buffer 700 is implemented, for example, by the storage device such as the RAM 203 and the magnetic disk 205 depicted in FIG. 2.

FIG. 7 is an explanatory diagram of one example of the contents of the determined character string buffer 700. In FIG. 7, a display screen 710 on the display 206 displays the nearby character string 511, the input area 512, the caret 514, the input character string 621, and conversion candidates 711. The conversion candidates 711 are results of a search of the text example DB 130, for text examples corresponding to “NAME”, among text examples corresponding to “ [symbol] ” of the input character string 621.

For example, the text examples “ [symbol] ”, “ [symbol] ” and “ [symbol] ” that are correlated with the phonetic spellings including the phonetic spelling “ [symbol] ” at the head are displayed as the conversion candidates 711. The input support apparatus 100, referring to the selection history, displays the conversion candidates 711, putting frequently selected ones at higher positions. For example, “ [symbol] ”, “ [symbol] ”, and “ [symbol] ” are indicated in descending order of past selection frequency. If among the text examples displayed as the conversion candidates 711, a text example has not yet been selected by the user, a determined character string data 701 is not stored in the determined character string buffer 700.

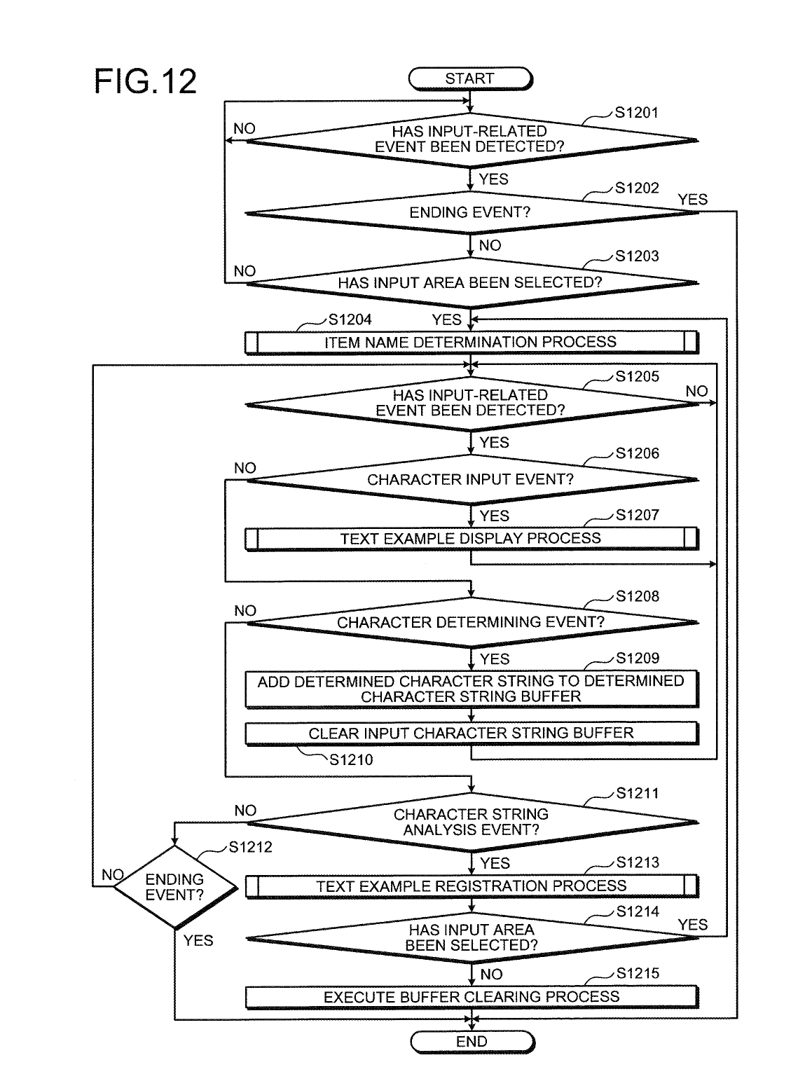

When the user, by operation of the keyboard 208 or the mouse 209, selects “ [symbol] ” from among the plural text examples displayed as the conversion candidates 711, the display screen 710 transitions to a display screen 720 and the text example “ [symbol] ” is determined and is input to the input area 512. The determined text example is stored to the determined character string buffer 700 as the determined character string data 701. Storage of the determined character string data 701 to the determined character string buffer 700 is performed in an input support process to be described later with reference to FIG. 12.

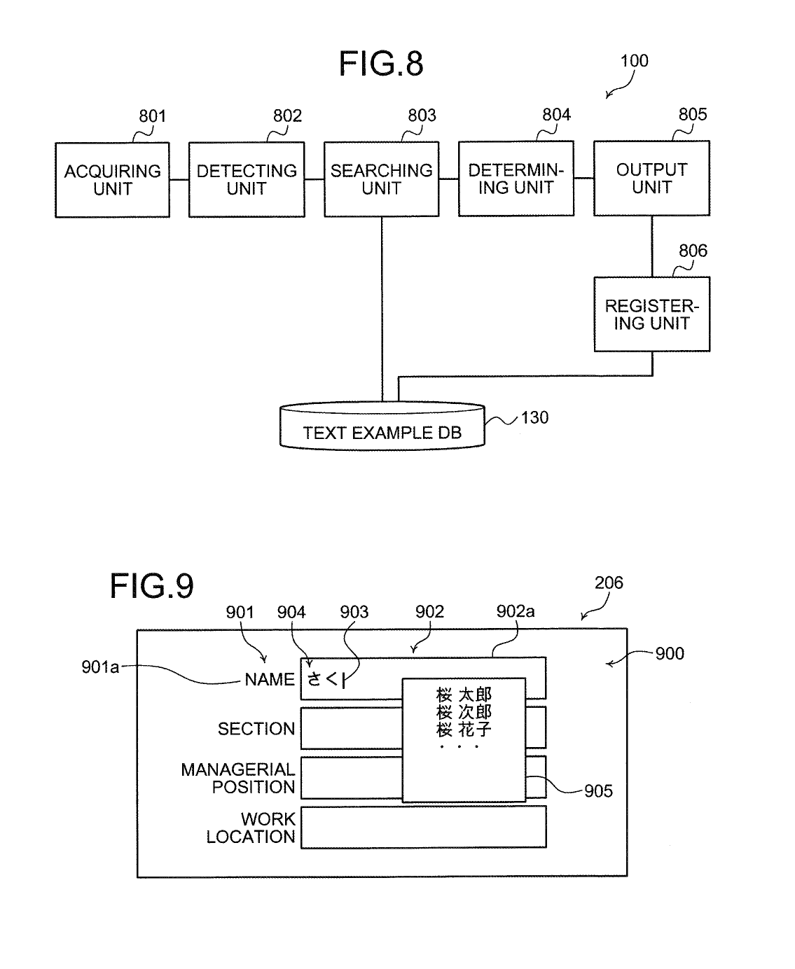

FIG. 8 is a block diagram of a functional configuration of the input support apparatus 100. In FIG. 8, the input support apparatus 100 is configured to include an acquiring unit 801, a detecting unit 802, a searching unit 803, a determining unit 804, an output unit 805, a registering unit 806, and the text example DB 130. The units of the acquiring unit 801 to the registering unit 806 have a function as a control unit and the respective functions thereof are implemented, for example, by causing the CPU 201 to execute a program stored in a storage device such as the ROM 202, the RAM 203, and the magnetic disk 205 depicted in FIG. 2, or by the I/F 207. Results of processing by each functional unit are stored to a storage device such as, for example, the RAM 203 and the magnetic disk 205.

The acquiring unit 801 acquires area image data of the area within a predetermined range of the input area on the image data to be displayed on the screen. The predetermined range is, for example, an area in near the same line as that of the input area and on the left side of the input area. The predetermined range may be set so that the range from the input area will differ from one application to another and, for example, may be set based on the assumption of the display location of the nearby character string for each application.

When the image is displayed, the acquiring unit 801 suffices to acquire the area image data out of the image data being displayed and is stored in a video RAM (VRAM). When the image is not displayed, namely, when the image data is not stored in the VRAM, the acquiring unit 801 suffices to request the area image data out of the non-displayed image data of an image browser and acquire from the image browser, the area image data satisfying the request. The area image data will be described in detail with reference to FIG. 11.

The detecting unit 802 detects a nearby character string of one character or more included in the area within the predetermined range by performing image analysis of the area image data acquired by the acquiring unit 801. For example, the detecting unit 802 detects a nearby character string out of the image by an optical character reader (OCR) function of optically reading in the image. In the detection of a nearby character string, the detecting unit 802 may detect a preset number of characters such as, for example, x bytes to the left of the input area.

While the specification describes that the nearby character string is to be detected by performing the image analysis of the area image data, the detection is not limited hereto. For example, configuration may be such that the nearby character string will be inquired of the application being executed and as a result, the nearby character string will be detected from the application. Since this can skip the performance of the image analysis, processing load can be alleviated.

Configuration may be such that, when the nearby character string cannot be acquired as a result of inquiring the nearby character string of the application being executed, the area image data will be acquired to detect the nearby character string. This makes it possible to limit the image analysis of the area image data to when the nearby character string cannot be detected.

The text example DB 130 correlates and stores the item name indicating the input item and the text example to be input to the input area of the input item. The text example is a word of one character or more, or a string of words. The item name is the input item such as the name, the section, the address, the managerial position, the work location, and the text example.

When an input character string of one character or more is input to the input area, the searching unit 803 searches the text example DB 130, for a text example that is stored correlated with the item name corresponding to the nearby character string detected by the detecting unit 802 and that includes the input character string at the head. The searching unit 803 may first retrieve text examples corresponding to the item name and from among these text examples, retrieve text examples including the input character string at the head; or may first retrieve text examples including the input character string at the head and from these text examples, retrieve text examples corresponding to the item name.

The output unit 805 outputs the text examples retrieved by the searching unit 803 as conversion candidates of the input character string. The conversion candidates output by the output unit 805 are displayed on the display 206. When, as a result of outputting the conversion candidates of the input character string by the output unit 805, a text example is selected by a user input operation, an input unit not depicted inputs the selected text example to the input area.

In the specification, the text example DB 130 is described as one storing the item name indicating the input item, the text example to be input to the input area of the input item, and the phonetic spelling of the text example, correlated with one another. The searching unit 803 searches for a text example that is stored correlated with the item name corresponding to the nearby character string detected by the detecting unit 802 and that is stored correlated with the phonetic spelling including the input character string at the head. This makes it possible to output a conversion candidate corresponding to the input character string in the case of the phonetic spelling input.

When the input of the input character string to the input area is determined, the registering unit 806 correlates and registers into the text example DB 130, the nearby character string detected by the detecting unit 802 taken as the item name and the determined input character string. The determined input character string is the text example and includes phonetic spelling. This makes it possible to newly register into the text example DB 130, the determined input character string and the nearby character string, correlated with each other.

If the input character string input to the input area is not registered in the text example DB 130, the registering unit 806 correlates and registers into the text example DB 130, the nearby character string and the determined input character string. Consequently, if the determined input character string is not registered in the text example DB 130, the nearby character string and the input character string can be correlated and registered into the text example DB 130. On the other hand, if the determined input character string is already registered in the text example DB 130, it is made possible not to re-register the input character string.

When plural text examples are retrieved by the searching unit 803, the determining unit 804 determines a display order according to the history information. The history information indicates the selection history of selection (by the user) of the text example displayed as the conversion candidate and is stored correlated with the item name and the text example. The history information is information such as the number of times, the frequency, date/time, etc. at which a given text example is selected by the user. The determining unit 804 determines a display order in which, for example, a text example more frequently selected in the past will be placed at a higher position.

The output unit 805 outputs input support information including the display order determined by the determining unit 804 and the conversion candidates of the input character string. The input support information output by the output unit 805 is displayed on the display 206.

An example will be described of the display screen of the conversion candidates to be displayed on the display 206. FIG. 9 is an explanatory diagram of one example of the display screen of the conversion candidates at the time of the input of a character into the input area of a “NAME” field. In FIG. 9, an input screen 900 displays a nearby character string 901, an input area 902, a caret 903, an input character string 904, and conversion candidates 905.

When the user operates and clicks the mouse 209 while the mouse pointer is positioned at an input area 902a, the IME is turned on and, with the caret 903 blinking, the input support apparatus 100 enters the state of accepting character input. The input support apparatus 100 detects a nearby character string 901a by performing image analysis of the area around the input area 902a. It is assumed that the detected nearby character string is “NAME”.

When the user operates the keyboard 208 and “ [symbol] ” is input to the input area 902a as the input character string 904, the input support apparatus 100 retrieves from the text example DB 130 and from among text examples corresponding to the item name “NAME”, text examples “ [symbol] ”, “ [symbol] ”, and “ [symbol] ” that are correlated with the phonetic spellings including “ [symbol] ” at the head. The input support apparatus 100, referring to the history of selection by the user, displays the conversion candidates 905, placing more frequently selected ones at higher positions. When the user, by operating the keyboard 208 or the mouse 209, selects any one of the conversion candidates 905, the selected text example is input to the input area 902a.

As a result, when input to the “NAME” field is performed, conversion candidates of the “NAME” can be displayed and conversion candidates desired by the user can be displayed.

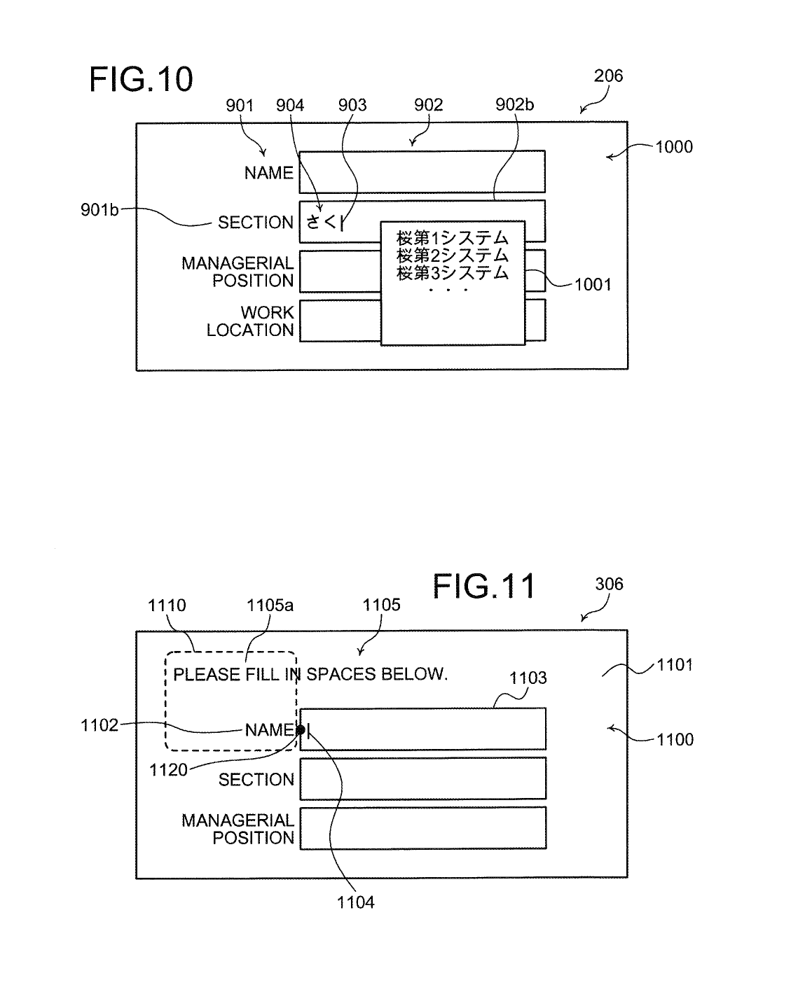

FIG. 10 is an explanatory diagram of one example of the display screen of the conversion candidates when characters are input to the input area of the “SECTION” field. In FIG. 10, an input screen 1000 displays the nearby character string 901, the input area 902, the caret 903, the input character string 904, and conversion candidates 1001.

When the user operates and clicks the mouse 209 while the mouse pointer positioned at an input area 902b, the IME is turned on and, with the caret 903 blinking, to the input support apparatus 100 enters the state of accepting character input. The input support apparatus 100 detects a nearby character string 901b by performing image analysis of the area around the input area 902b. It is assumed that the detected nearby character string is “SECTION”.

When the user operates the keyboard 208 and “ [symbol] ” is input to the input area 902b as the input character string 904, the input support apparatus 100 retrieves from the text example DB 130 and from among the text examples corresponding to the item name “SECTION”, the text examples “ [symbol] ”, “ [symbol] ”, “ [symbol] ”, and “ [symbol] ” that are correlated with the phonetic spellings including “ [symbol] ” at the head. The input support apparatus 100, referring to the history of selection by the user, displays the conversion candidates 1001, placing more frequently selected ones at higher positions. When the user, by operating the keyboard 208 or the mouse 209, selects any one of the conversion candidates 1001, the selected text example is input to the input area 902b.

As a result, when a character is input to the “SECTION” field, conversion candidates of the “SECTION” can be displayed and the conversion candidates desired by the user can be displayed.

An example will be described of the acquisition of the area image data with reference to FIG. 11. FIG. 11 is an explanatory diagram of one example of the acquisition of the area image data. In FIG. 11, an input screen 1100 displays an application 1101 being executed, a nearby character string 1102, an input area 1103, a caret 1104, and another character string 1105.

In the input screen, the caret 1104 is blinking inside the input area 1103 and the input area 1103 is in a state to accept character input. In the state to accept character input, the input support apparatus 100 detects the nearby character string 1102 of the input area 1103.

The nearby character string 1102 is detected by performing image analysis of character strings within a predetermined range 1110. While the predetermined range 1110 is indicated by a dotted line for convenience of description, it is not indicated by the dotted line in an actual screen.

The predetermined range 1110 is a range to be set based on a reference point 1120 at the left edge of the input area 1103. For example, the predetermined range 1110 is specified as the area on the left side of the input area 1103, based on the reference point 1120. By the image analysis, in the area on the left side of the input area 1103, in addition to “NAME”, for example, the character string such as “Please fill in” may be detected as depicted by the other character string 1105a. In this case, configuration may be such that “Space below” as well will be treated as a nearby character string, or a character string not matching the determination-use item name (see FIG. 4) pre-set for each application will be deleted from the nearby character string.

For example, the predetermined range 1110 may be specified as the area on the left side in an equivalent line, relative to the position of the input area 1103. In the detection of the nearby character string, the nearby character string may be specified as the character string to be displayed nearest the reference point 1120, out of the area on the left side in the equivalent line, relative to the position of the input area 1103. The reference point 1120 is not limited to the left edge of the input area 1103 and may be the center, the right edge, etc. of the input area 1103. In the case of vertical writing, the predetermined range 1110 may be the area above the input area 1103.

The input support process of the input support apparatus 100 will be described. FIG. 12 is a flowchart of one example of the input support process of the input support apparatus 100. In the flowchart of FIG. 12, the input support apparatus 100 judges if an input-related event has been detected (step S1201). The input-related event is a movement of the mouse pointer, on/off of the IME, the input/non-input of a character, etc. The input support apparatus 100 waits until an input-related event is detected (step S1201: NO).

When the input-related event has been detected (step S1201: YES), the input support apparatus 100 judges if the input-related event is an ending event (step S1202). An ending event is an event by which the IME is turned off and is, for example, the event by which the arrow-shaped mouse pointer is displayed and the caret stops blinking.

If the input-related event is an ending event (step S1202: YES), the input support apparatus 100 ends the series of operations according to this flowchart. If the input-related event is not an ending event (step S1202: NO), the input support apparatus 100 judges if the input area has been selected (step S1203). A case in which the input area is selected indicates the state in which the IME is turned on and the caret is blinking.

If the input area has not been selected (step S1203: NO), namely, if the input-related event is the movement of the mouse pointer, etc., the input support apparatus 100 proceeds to the operation at step S1201. If the input area has been selected (step S1203: YES), the input support apparatus 100 executes the item name determination process of performing analysis of the nearby character string around the input area (step S1204). Details of the item name determination process will be described later with reference to FIGS. 13 and 14.

The input support apparatus 100 judges if the input-related event has been detected (step S1205). The input support apparatus 100 waits until an input-related event is detected (step S1205: NO). When an input-related event has been detected (step S1205: YES), the input support apparatus 100 judges if the input-related event is a character input event by which a character is input (step S1206).

If the input-related event is a character inputting event (step S1206: YES), the input support apparatus 100 executes the text example display process of displaying conversion candidates of the input character (step S1207) and proceeds to the operation at step S1205. Details of the text example display process will be described later with reference to FIG. 15.

At step S1206, if the input-related event is not a character inputting event (step S1206: NO), the input support apparatus 100 judges if the input-related event is a character determining event to express that the character is determined (step S1208). If the input-related event is a character determining event (step S1208: YES), the input support apparatus 100 adds the determined character string to the determined character string buffer 700 (step S1209). The input support apparatus 100 then clears the input character string buffer 600 (step S1210) and goes to step S1205.

At step S1208, if the input-related event is not a character determining event (step S1208: NO), the input support apparatus 100 judges if the input-related event is a character string analysis event (step S1211). A character string analyzing event is, for example, a linefeed by depressing of an enter key, a movement of the caret to other input area by depression of a tab key, etc.

If the input-related event is not a character string analyzing event (step S1211: NO), the input support apparatus 100 judges if the input-related event is an ending event (step S1212). If the input-related event is an ending event (step S1212: YES), the input support apparatus 100 ends the series of operations according to this flowchart. If the input-related event is not an ending event (step S1212: NO), namely, if the input-related event is an event such as movement of the mouse pointer, the input support apparatus 100 proceeds to the operation at step S1205.

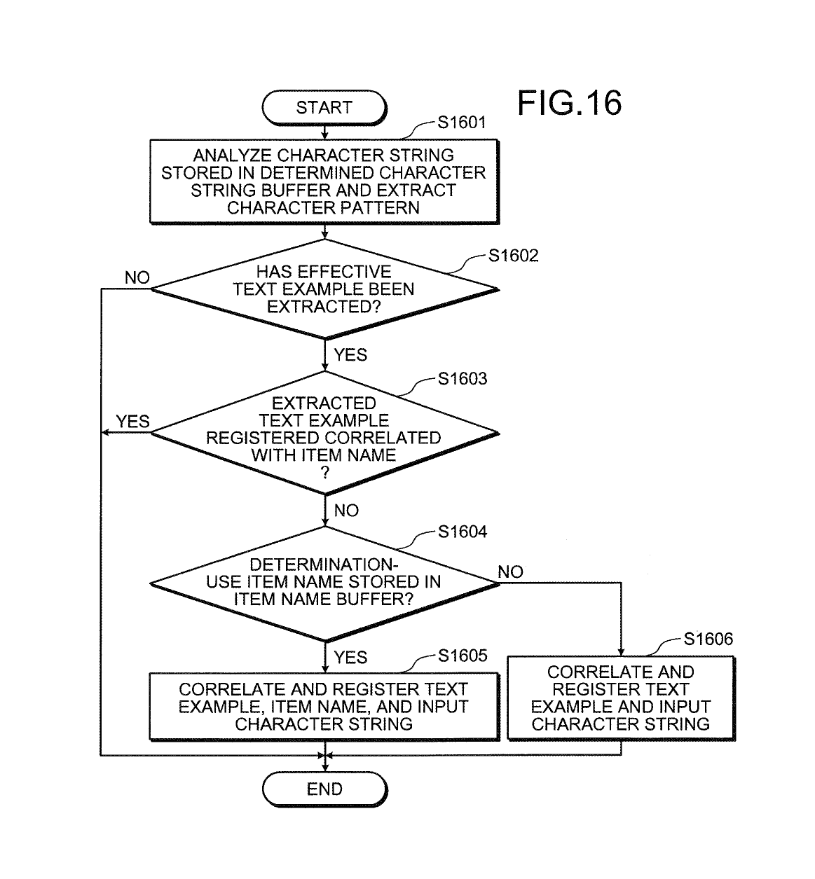

At step S1211, if the input-related event is a character string analyzing event (step S1211: YES), the input support apparatus 100 executes the text example registration process to perform registration of the text example (step S1213). Details of the text example registration process will be described later with reference to FIG. 16. The input support apparatus 100 judges if the input area has been selected (step S1214).

If the input area has been selected (step S1214: YES), the input support apparatus 100 proceeds to the operation at step S1204. If the input area has not been selected (step S1214: NO), the input support apparatus 100 performs a buffer clearing process (step S1215), ending the series of operations according to this flowchart. The buffer clearing process is a process of clearing the item name buffer 500, the input character string buffer 600, and the determined character string buffer 700.

The item name determination process of the input support apparatus 100 depicted at step S1204 of FIG. 12 will be described. FIG. 13 is a flowchart (1 of 2) of one example of the item name determination process of the input support apparatus 100. In the flowchart of FIG. 13, the input support apparatus 100 executes the buffer clearing process of clearing the item name buffer 500, the input character string buffer 600, and the determined character string 700 (step S1301).

The input support apparatus 100 executes specified area imaging process of imaging the area within a predetermined range of the input area (step S1302). The predetermined range of the input area indicates an area on the line equivalent to that of the input area and on the left side of the input area. The input support apparatus 100 executes an image analysis process of performing image analysis of the imaged specified area (step S1303). The input support apparatus 100 judges if a nearby character string has been detected (step S1304). If a nearby character string has not been detected (step S1304: NO), the input support apparatus 100 ends the series of operations according to this flowchart.

If a nearby character string has been detected (step S1304: YES), the input support apparatus 100 judges if plural nearby character strings have been detected (step S1305). If plural nearby character strings have not been detected (step S1305: NO), the input support apparatus 100 proceeds to the operation at step S1307. If plural nearby character strings have been detected (step S1305: YES), the input support apparatus 100 selects the nearby character string closest to the reference point 1120 (see FIG. 11) (step S1306).

The input support apparatus 100, referring to the determination-use item name file 400 depicted in FIG. 4, judges if an application ID indicating the identification information of the application being executed is registered in the determination-use item name file 400 (step S1307). If an application ID is not registered (step S1307: NO), the input support apparatus 100 ends the series of operations according to this flowchart. If an application ID is registered (step S1307: YES), the input support apparatus 100 reads in the determination-use item name from the determination-use item name file 400 depicted in FIG. 4 (step S1308).

The input support apparatus 100 judges if the determination-use item name is included in the nearby character string (step S1309). If the determination-use item name is not included in the nearby character string (step S1309: NO), the input support apparatus 100 ends the series of operations according to this flowchart. If the determination-use item name is included in the nearby character string (step S1309: YES), the input support apparatus 100 stores the determination-use item name included in the nearby character string to the item name buffer 500 (step S1310), ending the series of operations according to this flowchart.

When the plural nearby character strings are detected, the above processing makes it possible to store one determination-use item name including the nearby character string closest to the reference point 1120 in the item name buffer. In the text example display process to be described later, since this makes it possible to narrow down the item names depending on the application being executed, searching for a text example corresponding to the input character string and the item name can be performed quickly.

The item name determination process (2 of 2) will be described of the input support apparatus 100. In the item name determination process (1 of 2) depicted in FIG. 13, when plural nearby character strings are detected, one determination-use item name is stored to the item name buffer 500. In the item name determination process (2 of 2) depicted in FIG. 14, when plural nearby character strings are detected, plural determination-use item names will be stored to the item name buffer 500.

FIG. 14 is a flowchart (2 of 2) of one example of the item name determination process of the input support apparatus 100. In the flowchart of FIG. 14, the input support apparatus 100 executes the buffer clearing process of clearing the item name buffer 500, the input character string buffer 600, and the determined character string 700 (step S1401).

The input support apparatus 100 then executes the specified area imaging process of imaging the area within a predetermined range of the input area (step S1402). The predetermined range of the input area indicates the area on the line equivalent to that of the input area and on the left side of the input area. The input support apparatus 100 executes the image analysis process of performing the image analysis of the imaged specified area (step S1403). The input support apparatus 100 judges if a nearby character string has been detected (step S1404). If a nearby character string has not been detected (step S1404: NO), the input support apparatus 100 ends the series of operations according to this flowchart.

If a nearby character string has been detected (step S1404: YES), the input support apparatus 100, referring to the determination-use item name file 400 depicted in FIG. 4, judges if an application ID indicating the identification information of the application being executed is registered in the determination-use item name file 400 (step S1405). If an application ID is not registered (step S1405: NO), the input support apparatus 100 ends the series of operations according to this flowchart. If an application ID is registered (step S1405: YES), the input support apparatus 100 reads in the determination-use item name from the determination-use item name file 400 depicted in FIG. 4 (step S1406).

The input support apparatus 100 sets “i” to “1” indicating a value of “1 to n” of the detected nearby character strings “X1” to “Xn” (step S1407). The input support apparatus 100 selects the nearby character string Xi (step S1408). The input support apparatus 100 judges if the determination-use item name is included in the nearby character string Xi (step S1409). If the determination-use item name is not included in the nearby character string Xi (step S1409: NO), the input support apparatus 100 proceeds to the operation at step S1411.

If the determination-use item name is included in the nearby character string Xi (step S1409: YES), the input support apparatus 100 stores the determination-use item name included in the nearby character string Xi to the item name buffer 500 (step S1410). The input support apparatus 100 then adds “1” to “i” (step S1411).

The input support apparatus 100 judges if “i” is greater than “n” (step S1412). If “i” is equal to or less than “n” (step S1412: NO), the input support apparatus 100 proceeds to the operation at step S1408. If “i” is greater than “n” (step S1412: YES), the input support apparatus 100 ends the series of operations according to this flowchart.

When plural nearby character strings are detected, the above processing makes it possible to store the determination-use item names included in the nearby character strings to the item name buffer 500 for each application. For example, in the application of the application ID “001”, when other nearby character string as well as “NAME”, “SECTION”, and “MANAGERIAL POSITION” is detected as the nearby character string, only “NAME”, “SECTION”, and “MANAGERIAL POSITION” are stored to the item name buffer 500, with the other nearby character string being excluded. In the text example display process to be described later, since this makes it possible to narrow down the item names according to the application being executed, a text example corresponding to the input character string and the item name can be retrieved.

The text example display process of the input support apparatus 100 depicted at step S1207 of FIG. 12 will be described. FIG. 15 is a flowchart of one example of the text example display process of the input support apparatus 100. In the flowchart of FIG. 15, the input support apparatus 100 stores the input character to the input character string buffer 600 (step S1501). The input support apparatus 100 retrieves a text example including the input character string at the head and stored in the input character string buffer 600 (step S1502). A text example including the input character string at the head includes a text example stored correlated with the phonetic spelling including the input character string at the head.

The input support apparatus judges if the determination-use item name is stored in the item name buffer 500 (step S1503). If the determination-use item name is stored in the item name buffer 500 (step S1503: YES), the input support apparatus 100 retrieves from among text examples retrieved at step S1502, a text example corresponding to the item name stored in the item name buffer 500 (step S1504).

If the determination-use item name is not stored in the item name buffer 500 (step S1503: NO), the input support apparatus 100 proceeds to the operation at step S1505. When the determination-use item name is not stored in the item name buffer 500, the text example searching processing becomes ordinary processing without performing the search for a text example corresponding to the determination-use item name, namely, without performing the narrowing-down with respect to the determination-use item name.

The input support apparatus 100 judges if a text example has been retrieved (step S1505). If a text example has not been retrieved (step S1505: NO), the input support apparatus 100 ends the series of operations according to this flowchart. If a text example has been retrieved (step S1505: YES), the input support apparatus 100 prepares a text example candidate list based on the history information of each text example (step S1506). The input support apparatus 100 displays the prepared text example candidate list on the display 206 (step S1507), ending the series of operations according to this flowchart.

To supplement this flowchart, for example, in the case of Roman character input by which Roman characters are converted to phonetic spelling, each time two characters of a consonant and a vowel are input, a series of operations is performed. For example, in the case of inputting “ [symbol] ”, upon input of “s” and “a”, a series of operations is performed and a text example correlated with the phonetic spelling including “ [symbol] ” at the head is displayed. Upon input of “ [symbol] ” by “k” and “u” following “ [symbol] ”, a series of operations is performed again and a text example correlated with the phonetic spelling including “ [symbol] ”, with “ [symbol] ” followed by “ [symbol] ”, at the head is displayed.

When direct input is performed, for example, if one character of the alphabet is input, a series of operations is performed. For example, upon input of “s”, a series of operations is performed and a text example including “s” at the head is displayed. Upon input of “a” following “s”, a series of operations is performed again and a text example including “sa”, with “s” followed by “a”, at the head is displayed.

The above process makes it possible to perform a so-called incremental search by which a conversion candidate is searched for each time a character is input. The process also makes it possible to search for a text example corresponding to the input character string and the item name and to display text examples desired by the user.

Since a text example corresponding to the determination-use item name stored in the item name buffer 500 is retrieved as depicted at step S1504, the narrowing down of text examples can be performed and a quick and high-precision search can be performed.

While, in the above flowchart, a text example including the input character string at the head is firstly searched for at step S1502 and a text example corresponding to the item name is searched for thereafter at step S1504, the order of these operations may be reversed. For example, the operations at steps S1503 and S1504 may be performed before the operation at step S1502.

The text example registration operation at the input support apparatus 100 depicted at step S1213 of FIG. 12 will be described. FIG. 16 is a flowchart of one example of the text example registration process at the input support apparatus 100. In the flowchart of FIG. 16, the input support apparatus 100 analyzes the character string stored in the determined character string buffer 700 to extract a character pattern (step S1601). The extraction of the character pattern is performed, for example, by performing a morphological analysis by which such a part of a word of the character string that does not make a grammatical change or conjugation is treated as a minimum unit “morpheme” and the character string is resolved into “morphemes” and thereafter combining the text examples.

The input support apparatus 100 judges if an effective text example having reusability has been extracted (step S1602). An effective text example indicates, for example, a text example having a period at the end. If an effective text example has not been extracted (step S1602: NO), the input support apparatus 100 ends the series of operations according to this flowchart. If an effective text example has been extracted (step S1602: YES), the input support apparatus 100, referring to the text example DB 130, judges if the extracted text example is registered being correlated with the item name (step S1603).

If the extracted text example is registered being correlated with the item name in the text example DB 130 (step S1603: YES), the input support apparatus 100 ends the series of operations according to this flowchart. Though is not depicted, the input support apparatus 100, after step S1603: YES, updates the history information such as the number of times the text example has been selected.

If the extracted text example is not registered being correlated with the item name in the text example DB 130 (step S1603: NO), the input support apparatus 100 judges if the determination-use item name is stored in the item name buffer 500 (step S1604). If the determination-use item name is stored in the item name buffer 500 (step S1604: YES), the input support apparatus 100 registers the text example, correlated with the item name of the determination-use item name and the input character string, into the text example DB 130 (step S1605). The input support apparatus 100 ends the series of operations according to this flowchart.

The input character string is, for example, phonetic spelling “ [symbol] ” and the text example is the determined character string “ [symbol] ”. In the case of the direct input, the input character string and the text example are the same character string and in the operation at step S1605, the item name and the text example may be registered correlated with each other in the text example DB 130.

If the determination-use item name is not stored in the item name buffer 500 (step S1604: NO), the input support apparatus 100 correlates and registers the text example and the input character string into the text example DB 130 (step S1606), ending the series of operations according to this flowchart.

If the determination-use item name is stored in the item name buffer 500 with respect to a text example having reusability, the above processing makes it possible to register the item name of the determination-use item name, the input character string, and the text example, correlated with one another, into the text example DB 130. When the item name is not registered in the item name buffer 500, the input character string and the text example can be correlated and registered into the text example DB 130.

According to the input support apparatus 100 of the embodiment described above, the item name of the input area can be identified using a nearby character string, and a text example that is correlated with the item name and that includes the input character string at the head can be retrieved. This makes it possible to present, as the conversion candidate of the input character string and from among the text examples that include the input character string at the head, a text example corresponding to the item name of the input area and makes it easier to select the desired text example from among the conversion candidate list, enhancing the user convenience at the time of character input.

According to the input support apparatus 100, in the state of the caret blinking, the input area can be identified, a nearby character string around the input area can be detected, and a text example including the input character string can be retrieved. For example, according to the input support apparatus 100, a nearby character string can be detected by acquiring the area image data of the area within the predetermined range of the input area and performing image analysis of the acquired area image data. This makes it possible to realize the input support process without making code changes or setting changes with respect to the application, namely, irrespective of the application.

According to the input support apparatus 100, a nearby character string and a determined input character string can be correlated and registered into the text example DB 130, when the determined input character string is not registered in the text example DB 130. The determined input character string is a text example and includes the phonetic spelling. Consequently, when an input character string is input subsequently, the newly registered text example (determined input character string) can be presented as a conversion candidate of the input character string. If the determined input character string is already registered in the text example DB 130, since the registration of the determined input character string is not performed, overlapping registration of the text example can be prevented to suppress increases in memory capacity.

According to the input support apparatus 100, a text example can be retrieved that is stored correlated with the item name corresponding to the nearby character string and that is stored correlated with the phonetic spelling including the input character string at the head. Consequently, even in the case of converting the input character string of phonetic spelling, etc. to another character string of kanji, etc. as in the Japanese language, the text example in kanji desired by the user can be presented as a conversion candidate of the input character string of phonetic spelling. If the phonetic spelling and the text example are of the same alphabet, as in English, etc., the text example suffices to be output for several characters from the head of the character string.

According to the input support apparatus 100, when, as a result of outputting of retrieved text examples as conversion candidates of an input character string, a text example is selected via a user input operation, the selected text example can be input to the input area. This makes it possible to input the desired text example in the input area consequent to user selection. The text example selected by the user can be stored to the text example DB 130 as history information.

According to the input support apparatus 100, a display order can be determined according to history information indicating the history of input of the text example to the input area and search results can be displayed according to the determined display order. This makes it possible to display at higher positions, text examples having a high possibility of being selected by the user and to perform character input quickly and easily.

The input support method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

According to one aspect of the present invention, character input becomes more convenient for the user.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing an input support program that causes a computer to execute a process comprising:
detecting a nearby character string of one character or more included in an area within a predetermined range of a selected input area on an image displayed on a screen;
searching a database correlating and storing item names indicating input items and text examples corresponding to the input items, for a text example that is correlated with an item name indicating an input item corresponding to the detected nearby character string and that corresponds to the character string, upon receiving input of a character string of one character or more to the input area; and
outputting as a conversion candidate of the character string, the text example retrieved at the searching.

2. The computer-readable recording medium according to claim 1, the process comprising
correlating and registering into the database, the character string input to the input area and the detected nearby character string as the item name, upon determining the input of the character string to the input area.

3. The computer-readable recording medium according to claim 2, wherein
the correlating and registering includes correlating and registering into the database, the nearby character string and the character string input to the input area, when the character string input to the input area is not registered in the database.

4. The computer-readable recording medium according to claim 1, the process comprising
acquiring area image data of the area within the predetermined range of the input area on the image displayed on the screen, wherein
the detecting includes detecting the nearby character string of one character or more included in the area within the predetermined range by image analysis of the acquired area image data.

5. The computer-readable recording medium according to claim 1, wherein
the database correlates and stores the item name indicating the input item, the text example to be input to the input area of the input item, and a phonetic spelling of the text example, and
the searching includes searching for the text example that is stored correlated with the item name corresponding to the detected nearby character string and that is stored correlated with the phonetic spelling that includes the character string at the head.

6. The computer-readable recording medium according to claim 1, the process comprising:
inputting the retrieved text example to the input area when, as a result of outputting of the text example as a conversion candidate of the character string, the text example is selected via a user input operation.

7. The computer-readable recording medium according to claim 6, the process comprising:
determining a display order according to history information indicating history of selection of the text examples via user input operation, the determining being performed when a plurality of text examples are retrieved at the searching, wherein
the outputting includes outputting input support information that includes the determined display order and the conversion candidates of the character string.

8. An input support method executed by a computer, the input support method comprising:
detecting a nearby character string of one character or more included in an area within a predetermined range of a selected input area on an image displayed on a screen;
searching a database correlating and storing item names indicating input items and text examples corresponding to the input items, for a text example that is correlated with an item name indicating an input item corresponding to the detected nearby character string and that corresponds to the character string, upon receiving input of a character string of one character or more to the input area; and
outputting as a conversion candidate of the character string, the text example retrieved at the searching.

9. An input support apparatus comprising:
a processor programmed to:
detect a nearby character string of one character or more included in an area within a predetermined range of a selected input area on an image displayed on a screen;
search a database correlating and storing item names indicating input items and text examples corresponding to the input items, for a text example that is correlated with an item name indicating an input item corresponding to the detected nearby character string and that corresponds to the character string, upon receiving input of a character string of one character or more to the input area; and
output as a conversion candidate of the character string, the text example retrieved consequent to searching the database.
